(19) United States
(12) Patent Application Publication
(10) Pub. No.: US 2013/0070193 A1
(43) Pub. Date: Mar. 21, 2013

(54) METHOD OF STABILIZING A BLUE PHASE LIQUID CRYSTAL COMPOSITION

(71) Applicants: Pinar Kilickiran, Stuttgart (DE); Zakir Hussain, Stuttgart (DE); Frank Pleis, Stuttgart (DE); David Danner, Bermaringen (DE); Nadine Hollfelder, Rutesheim (DE); Gabriele Nelles, Stuttgart (DE)

(72) Inventors: Pinar Kilickiran, Stuttgart (DE); Zakir Hussain, Stuttgart (DE); Frank Pleis, Stuttgart (DE); David Danner, Bermaringen (DE); Nadine Hollfelder, Rutesheim (DE); Gabriele Nelles, Stuttgart (DE)

(73) Assignee: Sony Corporation, Tokyo (JP)

(21) Appl. No.: 13/636,286

(22) PCT Filed: Mar. 18, 2011
(86) PCT No.: PCT/EP2011/001346

§ 371 Date: Nov. 30, 2012

(30) Foreign Application Priority Data
Mar. 31, 2010 (EP) 10003615.1

(51) Int. Cl. C09K 19/02; G02F 1/13

(52) U.S. Cl. 349/183; 349/188

(57) ABSTRACT

The present invention relates to a method of stabilizing a blue phase liquid crystal composition. The present invention also relates to a method of producing a liquid crystal cell or display. Moreover, the present invention relates to a stabilized blue phase liquid crystal composition and to a liquid crystal cell or display prepared in accordance with the present invention. Moreover, the present invention relates to an electronic device comprising a stabilized liquid crystal composition.

The present invention relates to a method of stabilizing a blue phase liquid crystal composition. The present invention also relates to a method of producing a liquid crystal cell or display. Moreover, the present invention relates to a stabilized blue phase liquid crystal composition and to a liquid crystal cell or display prepared in accordance with the present invention. Moreover, the present invention relates to an electronic device comprising a stabilized liquid crystal composition.

Polymer network liquid crystals (PNLCs) and polymer dispersed liquid crystals (PDLCs) are important classes of materials having applications such as flexible displays, projection displays, electrically switchable windows, e-paper etc. Being the technology of the present and future, many studies have been performed on the experimental side. Development of new fabrication method with a refilling step paved the way for new applications of PNLCs and PDLCs. In this method, a polymer network is produced in an initial stage involving co-dispersion of liquid crystal and pre-polymer followed by UV curing and finally lift-off of the substrate and removal of the liquid crystal. The polymer network or cured polymer voids can be re-filled with any type of liquid crystals. Fabrication of PNLC and/or PDLC through this method results in improved properties. However, attempts are still under way to achieve PNLCs and/or PDLCs with ultrafast response speed.

Additionally, blue phases (BPs) are highly fluid self-assembled three-dimensional cubic defect structures that exist over a narrow temperature range (0.2-2 K) in highly chiral liquid crystals. Displays with BP do not require alignment layer and show ultrafast response speeds. There have been many attempts to improve the thermal stability of BP and to make them candidates for practical applications. Polymer stabilization of BP helped in achieving temperature range of about 60 K including room temperature and electro-optical switching with response time of the order of 10⁻⁴s. With ultrafast response speed and no alignment layer, BP systems could well be considered the technology of the future.

The current display technologies require, among others, very fast response times and new generation of innovative displays which are flexible, lightweight, low power and rugged. By applying flexible plastic substrates and roll-to-roll production, flexible liquid crystal displays have been rapidly maturing into a strong contender in the flexible display market. Recent advances of this revolutionary technology include ultra-thin displays, laser-cut segmented displays of variable geometry, and smart card applications. However, efforts still needed to achieve full-color; video rate flexible displays. Combination of PNLC and/or PDLC technologies with refilling method and ultra fast polymer stabilized BP technology, could be one of the few methods to achieve the displays of the future with ultrafast response speed and at the same time flexibility.
1. Fergason, U.S. Pat. No. 4,616,903 (FD. 83/03/21)
2. Reamey, U.S. Pat. No. 5,543,944 (FD. 94/10/31) D.
3. Kitzerow, H,-S. et. al. Liq. Cryst. 14, 911-916, 1993.
4. Kikuchi, H., Yokoda, M., Hisakado, Y., Yang, H., Kajiyama, T. Nature Mater. 1, 64-69, 2002.
5. Coles, H. J., Pivnenko, M. N. Nature, 436/18, 997-1000, 2005.
6. Iwata, T., Suzuki, K., Amaya, N., Higuchi, H., Masunaga, H., Sasaki, S., Kikuchi, H. Macromolecules, 42, 2002-2008, 2009.
7. Ge, Z., Gauza, S., Jiao, M., Xianyu, H., Wu, S. T. Appl. Phys. Lett. 94, 101-104, 2009.
8. Ding H. L., Zhao T, Cheng Y. X., Pang Y. H., Xu H., Shi G. Y., Jin L. T. Science in China Series B: Chemistry 50, 358-363, 2007.
9. Masutani A., Schueller B., Roberts A., Yasuda A. WO 2006/087095.
10. Roberts A, Masutani A., Yasuda A., Schueller B., Hashimoto S., Matsui E., 30 Jul. 2005, EP1541661
11. Kilickiran P., Masutani A., Roberts A., Tadeusiak A., Sandford G., Nelles G., Yasuda A., 3 Oct. 2007, EP1840188
12. Kilickiran P., Roberts A., Masutani A., Nelles G., Yasuda A., 3 Oct. 2007, EP1840188

Present electronic device display technologies require non-flexible as well as flexible displays with ultrafast response speeds, on the order of a few milliseconds. The state of the art liquid crystal systems currently used in displays do not fulfill the requirement of such fast turn-on and turn-off times. Moreover, it is difficult to implement a fluid system, such as liquid crystals in flexible substrates to achieve a flexible display. Consequently, there is a need in the art for integrated systems which have ultrafast switching liquid crystal materials.

Accordingly, it was an object of the present invention to stabilize blue phase liquid crystal systems in such a manner that they can be used in display devices. It was also an object of the present invention to provide for such improved stabilized blue phase liquid crystal compositions which can be used in flexible displays.

The objects of the present invention are solved by a method of stabilizing a blue phase liquid crystal composition, said method comprising:
a) providing a liquid crystal composition, said liquid crystal composition being capable of forming a blue phase, said liquid crystal composition comprising a liquid crystal material and a monomer which can be induced to polymerize,
   b) inducing the liquid crystal composition to form a blue phase and maintaining said liquid crystal composition in said blue phase,
c) inducing said monomer to polymerize whilst said liquid crystal composition is maintained in said blue phase, thereby stabilizing said liquid crystal composition,
   wherein, prior to steps b) and c), in step a) a solid porous matrix is prepared or provided which has an interstitial space which can be filled by a liquid material or liquid crystal material, and, also prior to step b) and c), said liquid crystal composition is introduced into said interstitial space of said solid porous matrix.

In one embodiment solid porous matrix is a polymeric solid porous matrix.

In one embodiment said polymeric solid porous matrix is prepared by polymerization induced phase separation (PIPS), thermal induced phase separation (TIPS) or solvent induced phase separation (SIPS).

In one embodiment step b) is performed by adjusting the temperature of said liquid crystal composition to a temperature range in which said blue phase forms, and maintenance of said blue phase is achieved by maintaining said liquid crystal composition in said temperature range.

In one embodiment step c) is performed by application of energy to said liquid crystal composition, preferably by irradiation of said liquid crystal composition using electromagnetic radiation, preferably UV light.

In one embodiment said interstitial space of said solid porous matrix has pores which have an average diameter in the range of from 10 nm to 1 mm, preferably from 50 nm to 100 μm.

In one embodiment, in step a), preparation of said solid porous matrix is performed on a substrate to support said solid porous matrix.

In one embodiment said introducing said liquid crystal composition into said interstitial space of said solid porous matrix is performed by one or several of the following: soaking, imbibing, flooding, washing, covering said solid porous matrix with said liquid crystal composition.

In one embodiment the liquid crystal composition additionally includes a chiral material. A person skilled in the art knows suitable chiral materials. An example thereof is ISO(6-OBA)2 which is 2,5-bis-[40-(hexyloxy)-phenyl-4-carbonyl]-1,4;3,6-dianhydride-D-sorbitol.

The objects of the present invention are also solved by a method of producing a liquid crystal cell or display, said cell or display comprising a stabilized blue phase liquid crystal composition, said method comprising the steps:

performing the method of stabilizing a blue phase liquid crystal according to the present invention as outlined above, wherein step c) of said method of stabilizing is performed while said solid porous matrix is sandwiched between two substrates, wherein each of said two substrates comprises at least one electrode in contact with said solid porous matrix. In one embodiment, step c) of said method of stabilizing is performed while said solid porous matrix is sandwiched between a first substrate and a second substrate, wherein said first substrate has a first electrode in contact with said solid porous matrix, and said second substrate has a second electrode in contact with said solid porous matrix. In one embodiment, said first electrode is patterned. In another embodiment, said second electrode is patterned. In yet another embodiment, both said first and said second electrode are patterned. Examples of patterned electrodes are interdigitated electrodes, such as IPS type (in plane switching) or FFS type (fringe field switching) electrodes. In a simple case, an electrode may be an ITO layer on one of the substrates which ITO layer may be patterned or non-patterned. In one embodiment, both said first electrode and said second electrode are an ITO layer on said first and second substrate, respectively, and in contact with said solid porous matrix. Such ITO layer on said first and/or second substrate may be patterned or non-patterned.

In one embodiment said two substrates are made of glass or a flexible bendable material.

In one embodiment said flexible bendable material is a plastic, such as polyethylene terephthalate (PET).

The objects of the present invention are also solved by a stabilized blue phase liquid crystal composition prepared by the method of stabilizing a blue phase liquid crystal composition, as outlined above.

The objects of the present invention are also solved by a liquid crystal cell or display prepared by the method of producing a liquid crystal cell or display in accordance with the present invention, as outlined above.

The objects of the present invention are also solved by an electronic device comprising a stabilized liquid crystal composition or a liquid crystal cell or display according to the present invention.

In one embodiment, the device is selected from the group comprising, electronic book reader, portable game console, phone, screen, such as mobile device screens, computer screen, tv screen, advertisement screen, remote control, information display, e-signage, with non-flexible as well as flexible displays.

The objects of the present invention are also solved by the use of the device according to the present invention as a color display, for example as a colored e-book reader. The device according to the present invention can make use of the different light refraction properties of the blue phase material at different voltages. The device can be used in or as a color display for various applications, for example a colored e-book reader.

The present inventors have surprisingly found that it is possible to stabilize a blue phase liquid crystal composition by inducing a polymer to form in said blue phase liquid crystal composition, whilst said blue phase liquid crystal composition is contained in the interstitial space of a solid porous matrix. In preferred embodiments, such solid porous matrix is the polymer network of a polymer dispersed liquid crystal cell (PDLC).

Various techniques have been developed to achieve such formation of a polymer network which are used depending on the individual circumstances. For example, when a pre-polymer material is miscible with a liquid crystal compound a phase separation by polymerization is used. This technique is referred to as polymerization-induced phase separation (PIPS). A homogeneous solution is made by mixing the pre-polymer with the liquid crystal. Thereafter a polymerization is achieved through a condensation reaction, as with epoxy resins, or through a free radical polymerization, as with vinyl monomer catalyzed with a free radical initiator such as benzoyl peroxide; or by a photo-initiated polymerization. Upon polymerization the solubility of the liquid crystal decreases as the polymers lengthen until the liquid crystal forms droplets within a polymer network, or an interconnected liquid crystal network forms within a growing polymer network, or the polymer forms globules within a liquid crystal sea. When the polymer starts to gel and/or crosslink it will lock the growing droplets or the interconnected liquid crystal network thereby arresting them/it in their/its state at that time. The droplet size and the morphology of droplets or the dimensions of the liquid crystal network are determined during the time between the droplet nucleation/initiation of network formation and the gelling of the polymer. Important factors are the rate of polymerization, the relative concentrations of materials, the temperature, the types of liquid crystal and polymers used and various other physical parameters, such as viscosity, solubility of the liquid crystal in the polymer. Reasonably uniform size droplets can be achieved by this technique. Sizes prepared in the past have ranged from 0.01 μm-30 μm. Polymerization induced phase separation (PIPS) is a preferred method for forming PDLC films. The process begins with a homogeneous mixture of liquid crystal and monomer or pre-polymer. Polymerization is initiated to induce phase separation. Droplet size and morphology are determined by the rate and the duration of polymerization, the types of liquid crystal and polymers and their proportions in the mixture, viscosity, rate of diffusion, temperature and solubility of the liquid crystal in the polymer (West, J. L., Phase-separation of liquid-crystals in polymer. Molecular Crystals and Liquid Crystals, 1988. 157: p. 427-441, Golemme, A., Zumer, S., Doane, J. W., and Neubert, M. E., Deuterium nmr of polymer dispersed liquid crystals. Physical Review a, 1988. 37(2): p. 599-569, Smith, G. W. and Vaz, N. A., The relationship between formation kinetics and microdroplet size of epoxy based polymer-dispersed liquid-crystals. Liquid Crystals, 1988. 3(5): p. 543-571, Vaz, N. A. and Montgomery, G. P., Refractive-indexes of polymer-dispersed liquid-crystal film materials—epoxy based system. Journal Of Applied Physics, 1987. 62(8): p 3161-3172). In ultraviolet light (UV) initiated polymerization, the rate of curing may be changed by changing the light intensity (Whitehead Jr, J. B., Gill, N. L., and Adams, C., Characterization of the phase separation of the E7 liquid crystal component mixtures in a thiol-ene based polymer. Proc. SPIE, 2000. 4107: p. 189). The PIPS method using free-radical polymerization is by far the most studied, and the majority of free-radical polymerization systems are initiated by UV light. The process has several advantages over other methods such as, better phase separation, uniform droplet size, and better control of the droplet size.

Another technique used for obtaining PDLC composites is thermal induced phase separation (TIPS). This technique can be used for liquid crystal materials and thermoplastic materials which are capable of forming a homogenous solution above the melt temperature of the polymer. The homogenous solution of liquid crystal in the thermoplastic melt is cooled below the melting point of the thermoplastic material, thereby causing a phase separation of the liquid crystal. The droplet size of the liquid crystal is determined by the rate of cooling and a number of other material parameters. Examples of TIPS-prepared composites are polymethylmethacrylate (PMMA) and polyvinylformal (PVF) with cyanobiphenyl liquid crystal. Generally, the concentrations of liquid crystals required for TIPS-film are larger in comparison to PIPS-prepared films.

Another technique used to prepare polymer dispersed liquid crystal composites is solvent-induced phase separation (SIPS). This makes use of a liquid crystal and a thermoplastic material dissolved in a common solvent thereby forming a homogenous solution. The ensuing evaporation of the solvent results in phase separation of the liquid crystal, droplet formation and growth, and polymer gelation. Solvent evaporation can also be used in conjunction with thermal processing of materials which melt below their decomposition temperature. First of all films are formed on a suitable substrate using standard film coating techniques, e. g. doctor blading, spin coating, web coating, etc. The solvent is thereafter removed with no concern of droplets size or density. Then the film is warmed again to re-dissolve the liquid crystal in the polymer and then cooled at a rate which is chosen to give the desired droplet size and density. In effect, the latter example is a combination of SIPS with TIPS.

A further technique used for the construction of PDLC films is the emulsification of the liquid crystal into an aqueous solution of a film-forming polymer (“emulsion method”). This emulsion is coated onto a conductive substrate and allowed to dry. As the film dries, the polymer forms a solid phase which both contains and supports the dispersed liquid crystal droplets. Lamination of a second conductive substrate leads to the final PDLC film. One common feature of emulsion-based systems is that the coating undergoes a significant volume change as the film dries. This shrinkage tends to deform the droplets, which are spherical in solution, into flattened (oblate) spheroids in the PDLC film. This shape anisotropy affects the alignment of the liquid crystal within the film cavities. For example, bipolar droplets in emulsionbased films form with the droplets symmetry axis aligned in the film plane, which in turn affects the electro-optical properties of the film.

All these methods are encompassed and envisageable by the present invention for formation of the solid porous matrix.

In one embodiment of the method according to the present invention, the polymer matrix is formed in the presence of a first material, preferably a liquid crystal material, which—after formation of the polymer matrix—is removed and replaced by a second material that is liquid crystalline. In order for this removal and replacement step to take place, the method involves splitting a cell apart in order to wash out the first material remaining in the polymer matrix.

According to the present invention, it is also envisaged to form the polymer network of the PDLC by preparing a porous polymer matrix out of monomers between a first and a second substrate, wherein pores of the porous polymer matrix are filled with a first material, preferably a first liquid crystal material, thereafter lifting off the second substrate from a face of said porous polymer matrix, and removing the first material from the porous polymer matrix, and placing a third substrate on a face of the porous polymer matrix from which face the second substrate has been lifted off in step b), and filling some or substantially all of said porous polymer matrix with a second material which is the liquid crystalline composition being capable of forming a blue phase. Liquid crystal compositions which are capable of forming a blue phase are known to someone skilled in the art.

The present invention is related to new systems where blue phase materials are stabilized in an already formed polymer network (e.g. PDLC's polymer network) which can be used -not only but most importantly-for ultrafast flexible displays. The claimed systems can be incorporated with all type of liquid crystals showing blue phase and blue phase stability temperature ranges could be achieved to 60K or above including room temperature. To create a polymer network, any UV or heat or other curable monomer (pre-polymer) can be used. Reported systems work well with PET as substrate instead of glass extending their use in the flexible displays. From the stabilization and response speed data of the reported system in display test cells, such systems will have very fast switching and can be used for flexible displays. Additionally, making use of the different light refraction properties of blue phase (BP) materials at different voltages one can also use such a system to make colored displays, to be used in various applications, for example a colored e-book reader.

As used herein, the term “blue phase” is meant to refer to a state of a liquid crystal composition or material, wherein double twist structures occur over extended dimensions. In one embodiment, such blue phase state is a self-assembled three-dimensional cubic defect structure of a liquid crystal material/composition.

As used herein, the term “monomer” is also meant to refer to oligomers or pre-polymers which may be induced to form a polymer by polymerization. A person skilled in the art will be able to identify liquid crystal compositions which are capable of forming a blue phase. One example of a liquid crystal composition forming a blue phase is indicated further below. In principle, any kind of nematic liquid crystal can be brought to a blue phase state at a certain temperature by the help of the presence of chiral materials.

Examples of monomers suitable for forming a polymer network are acrylate monomers, such as ethylhexyl acrylate.

Electronic device display technologies require displays with high brightness and contrast, low power consumption and above all, ultrafast response speeds. For flexible displays, polymer thin film technology is being explored and in particular, polymer networks (like e.g. PDLC's polymer network) are of interest. In these materials it is important to achieve good phase separation of the components with minimal co-dissolution. Therefore, combination of two technologies i.e. an already formed polymer network like in the present case PDLC's polymer network (leads to flexible displays) and BP (with ultrafast response speeds and no alignment layer) could be considered an option for future generation of flexible displays with desired features.

The present invention covers new systems where blue phase materials are stabilized in already existing polymer networks, stability of such systems in PET material as an example is investigated and response speeds of the test cells are measured. The inventors suggest, it is necessary to stabilize the BP in an existing polymer network so as to achieve flexible display applicable systems. Otherwise, the polymer content of a polymer stabilized BP alone is too little to make it a non-fluidic system so as to be used easily in a flexible substrate towards a flexible display.

Furthermore, replacing glass with PET as substrate, for example, worked which is an indication of the potential of such system for flexible displays.

### BRIEF DESCRIPTION OF THE PREFERRED EMBODIMENTS

To achieve the objectives and in accordance with the purpose of the invention, as embodied and broadly described herein, one or more of the systems shown below as examples are used.

The current display technologies require flexible displays and displays with high contrast, low power consumption, and very fast response times. An electro-optical switching with response times of the order of 10⁻⁴s for the stabilized blue phases at room temperature has already established their importance. Therefore, ultrafast response speeds of the displays (non-flexible as well as flexible) with electro-optic effects of the optically isotropic state (blue phase) induced by the incorporative effects of polymer networks and the chirality of liquid crystal, can be achieved. If the blue phase materials can be stabilized by means of inducing a polymerization of monomers, present in the liquid crystal composition, in an already formed polymer network (like e.g. of PDLC's polymer network) then the results will be an LCD with improved response speeds and flexibility, which is dimensionally confined and can be handled easily.

In a preferred embodiment, the systems according to the present invention are polymer networks (e.g. PDLC's polymer network) with incorporated and stabilized blue phases, which the inventors would like to refer as new systems to be used in LCDs as ultrafast systems. With these new hybrid systems very fast response speeds, stability as well as compatibility with plastic substrates like PET (Polyethylene terephthalate) can be achieved.

The main advantage of the BP-polymer network systems reported here is hidden in their hybrid structures. The systems in accordance with the present invention have three main properties i.e. 1) stability provided by polymer networks such as PDLC's polymer network or other polymer networks with sufficient voids to host a BP system, 2) ultrafast response speeds provided by polymer stabilized blue phase or optically isotropic state and 3) compatibility with plastic substrates such as PET for example.

Additionally, by making use of the voltage dependent light refraction properties of BP materials in such polymer network-BP hybrids one can also make colored displays, to be used in various applications, for example a colored e-book reader.

Below examples are indicated with respect to the blue phase LC materials used in the system, structure of PDLC before and after washing, test cell with blue phase stabilized in PDLC and images of blue phase stabilized in the polymer networks (of e.g. PDLC's polymer network in the present case).

In the following, reference is made to the figures, wherein

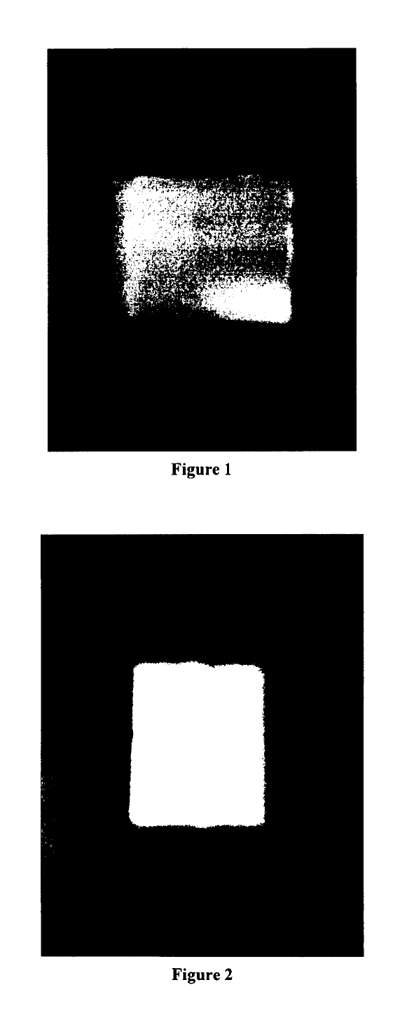

FIG. 1 shows a PDLC test panel before washing, but after lift-off of a substrate;

FIG. 2 shows the same PDLC test panel after washing;

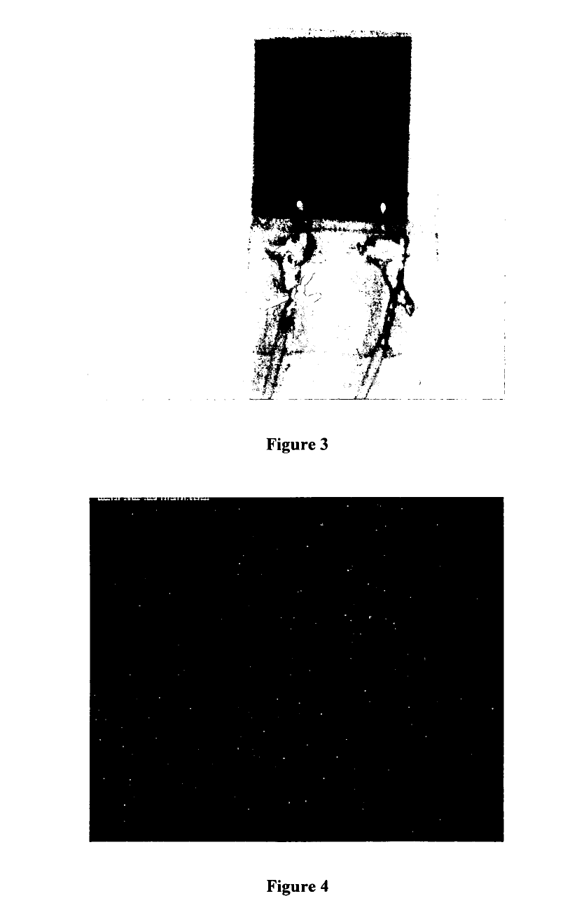

FIG. 3 shows the PNLC test display panel after blue phase is stabilized, i.e. after the monomer present in the liquid crystal composition has been induced to polymerize;

FIG. 4 shows a POM (polarized optical microscopy) image of the stabilized blue phase in the polymer network of for example a PDLC, wherein FIGS. 1-4 have all been taken at room temperature;

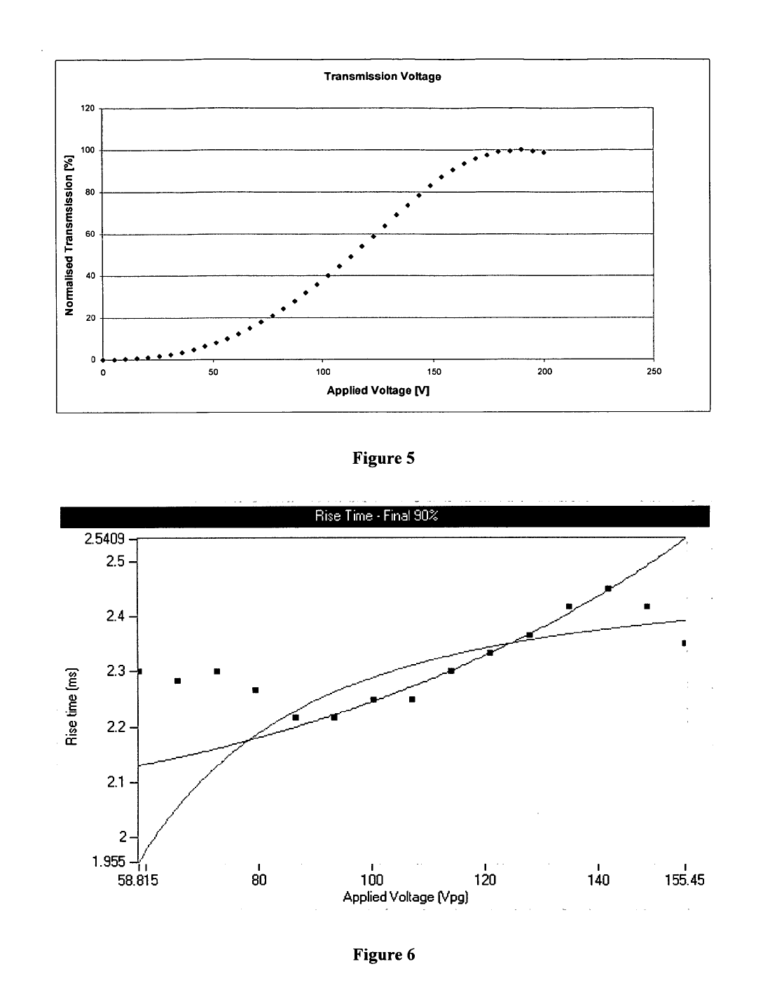

FIG. 5 shows a transmission-voltage curve of a stabilized blue phase-PNLC (BP-PNLC);

FIG. 6 shows the rise time of such BP-PNLC against the driving voltage (“applied volt-age”); and

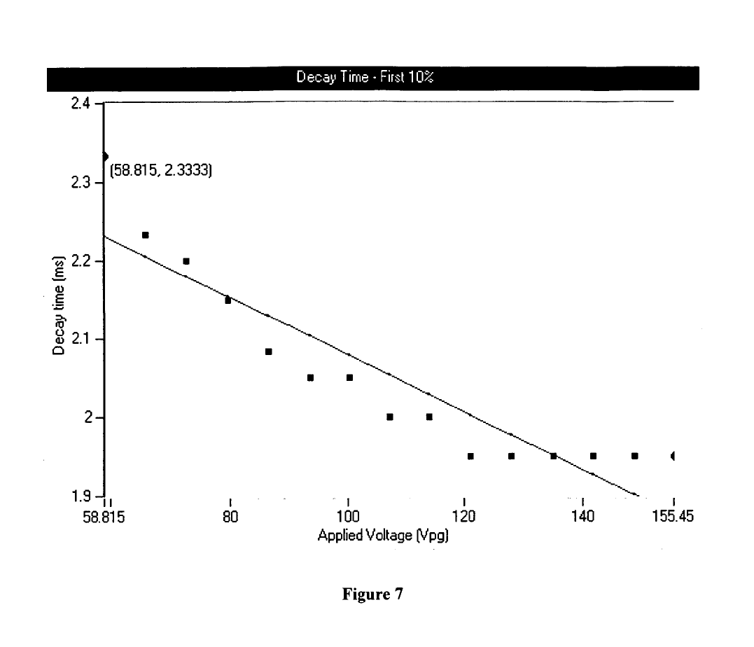

FIG. 7 shows the decay time of such BP-PNLC against the driving voltage (“applied volt-age”).

The rise time of FIGS. 6 and 7 is approximately 2.5 ms and the decay time is approximately 2 ms, which is an indication that the established systems have a very fast response speed.

Moreover, reference is made to the following example which is given to illustrate, not to limit the present invention:

### EXAMPLE

A typical system where blue phase is stabilized in the polymer network is given as an example below:

In a typical example, the present inventors first prepared a polymer network of PDLC, filled the already prepared polymer network with blue phase materials and finally stabilized the BP materials within this polymer network by polymerizing a monomer. For the preparation of PDLC, the inventors used nematic LC (from Merck), UV curable polymer (from Nematel), nano/micro particles (from Nippon Shokubai) and polymer spacers (from Hayakawa).

In order to prepare a pre-PDLC solution, the inventors mixed nematic LC and UV-curable polymer and from this solution we took 96 wt % and mixed with nano/micro particles and polymer spacers and stirred the mixture for 30 min. They then put the mixture in an ultrasonic bath for 10 min followed by stirring at least for overnight to ensure good homogeneous mixing.

For the preparation of substrates to be used for PDLC, the inventors cleaned both substrates and applied water repellant to the lift-off substrate. Then they placed the above mentioned pre-PDLC solution on the lift-off substrate and gently covered the substrate with the front substrate. The inventors then polymerized the UV curable monomers using UV light which resulted in PDLC formation. After this homogenous polymerization they peeled off the lift-off substrate.

Following the procedure, they placed the front-glass substrate with PDLC in an alcohol based solvent and stirred for 3 min on the stirring stage to dissolve and remove the LC. Finally the inventors removed the alcohol based solvent by drying on a heating stage or under vacuum. The polymer network which is prepared through PDLC preparation was now ready for refilling step where they refilled the polymer network with blue phase materials.

Blue phase materials used for refilling in the polymer network are given below:

LC-mixture JC-1041XX (a mixture of fluorinated biphenyl cyclohexyl systems from Chisso company) and 5CB (from Chisso); Acrylic reactive monomers RM257 (from Merck) and EHA (ethyl hexaacrylate), chiral dopant ISO(6OBA)2 and photo initiator DMPAP. The inventors made the proof of principle with materials as given here but the principle works with other materials, such as any type of nematic liquid crystal mixture with the capability of inducing optically isotropic state (blue phase) by the incorporative effects of a polymer network and the chirality of liquid crystals.

The BP mixture containing JC-1041XX liquid crystals (˜44.74 mol %), 5CB LC (˜43.44 mol %), chiral dopant (˜4.89 mol %), monomer RM257 (˜2.6 mol %), monomer EHA (˜4 mol %) and photoinitiator ˜0.33 mol %) was mixed and stirred to obtain homogeneity and from this mixture few drops were placed on the dried polymer network mentioned above. Once mixture covered the whole polymer network, it was covered with a top substrate and was heated to get the isotropic phase by placing the test cell on heat plate for 30 min. The whole procedure was carried out in dark room in order to avoid any polymerization of the monomers present in the BP mixture. After the test cell was cooled down, it was placed on the optical microscope and heated on the heating stage (Linkam LTS350) to isotropic phase and cooled down afterwards with the help of liquid nitrogen (Linkam LNP) at a rate of 0.1° C./minute. Once the BP appeared during the cooling process, the temperature of the test cell kept maintained where BP occurs and the system was illuminated with UV light. This step is to polymerize the reactive monomers present in the BP mixture in order to stabilize the BP. After polymerization, the cell was allowed to cool down to room temperature and it was then ready for the measurement of BP temperature range and electro-optical properties.

Display test cells with polymer network (e.g. of PDLC's polymer network in the present example) before washing (after lift-off) (FIG. 1), after washing (FIG. 2), after stabilization (FIG. 3) and POM image of stabilized BP in the polymer network (FIG. 4) (of e.g. PDLC) are shown in the following figures. All pictures are taken at room temperature (22° C.).

Response speeds of the BP stabilized in PDLC polymer network is given in the following details. The figures show transmission-voltage curve (FIG. 5) and rise (FIG. 6) & decay time (FIG. 7). It is clear that driving voltage is quite high (V10=58; V90=155) but it is a phenomenon associated with polymer stabilized blue phase and by using different LC materials, different monomers to stabilize BP through polymerization as well as by modifying the electrode structure it can be reduced. The figures also show the rise and decay time which is ˜2.5 ms and ˜2 ms respectively which is an indication that the established systems have ultrafast response speeds.

Finally, in polymer network hosted and stabilized blue phase is stable over a temperature range starting from less than 0° C. up to 52° C.

The features of the present invention disclosed in the specification, the claims and/or in the accompanying drawings, may, both separately, and in any combination thereof, be material for realising the invention in various forms thereof.

1. A method of stabilizing a blue phase liquid crystal composition, the method comprising:
a) introducing a liquid crystal composition, which forms a blue phase and comprises a liquid crystal material and a polymerizable monomer into an interstitial space of a solid porous matrix;
b) inducing the liquid crystal composition to form a blue phase and maintaining the liquid crystal composition in the blue phase; and
c) polymerizing the polymerizable monomer while the liquid crystal composition is maintained in the blue phase, thereby stabilizing said liquid crystal composition;

2. The method to of claim 1, wherein the solid porous matrix is a polymeric solid porous matrix.

3. The method to of claim 2, wherein the polymeric solid porous matrix is obtained by polymerization induced phase separation (PIPS), thermal induced phase separation (TIPS) or solvent induced phase separation (SIPS).

4. The method of claim 1, wherein the inducing b) comprises adjusting the temperature of the liquid crystal composition to a temperature range in which the blue phase forms, and maintenance of the blue phase is achieved by maintaining the liquid crystal composition in the temperature range.

5. The method of claim 1, wherein the polymerizing c) comprises applying energy to the liquid crystal composition.

6. The method of claim 1, wherein the interstitial space of the solid porous matrix comprises pores having an average diameter in the range of from 10 nm to 1 mm.

7. The method of claim 1, wherein the solid porous matrix is on a substrate, which supports the solid porous matrix.

8. The method of claim 1, wherein the introducing a) comprises at least one selected from the group consisting of: soaking, imbibing, flooding, washing, and covering the solid porous matrix with the liquid crystal composition.

9. A method of producing a liquid crystal cell or display, the cell or display comprising a stabilized blue phase liquid crystal composition, the method comprising:
stabilizing a blue phase liquid crystal by performing the method of claim 1, wherein the polymerizing c) is performed while the solid porous matrix is sandwiched between two substrates, wherein each of the two substrates comprises an electrode in contact with the solid porous matrix.

10. The method of claim 9, wherein the two substrates comprise glass or a flexible bendable material.

11. The method of claim 10, wherein the flexible bendable material is a plastic.

12. A stabilized blue phase liquid crystal composition, obtained by the method claim 1.

13. A liquid crystal cell or display, obtained by the method claim 9.

14. An electronic device, comprising a stabilized liquid crystal composition of claim 12.

15. The device to of claim 14, which is selected from the group consisting of an electronic book reader, a portable game console, a phone, a screen, a computer screen, a tv screen, an advertisement screen, a remote control, an information display, an e-signage, a non-flexible display, and a flexible displays display.

16. The device of claim 14, which is a color display.

17. The method of claim 5, wherein the energy is applied by irradiation.

18. The method of claim 17, wherein the irradiation comprises UV light.

19. The method of claim 1, wherein the interstitial space of the solid porous matrix comprises pores having an average diameter in the range of from 50 nm to 10 μm.

20. An electronic device comprising a liquid crystal cell or display of claim 13.
